(19) United States
(12) Patent Application Publication
(10) Pub. No.: US 2017/0243201 A1
(43) Pub. Date: Aug. 24, 2017

(54) CREATION OF MERCHANT EVENTS

(71) Applicant: iZettle Merchant Services AB, Stockholm (SE)

(72) Inventor: Lisa GUSTAFSSON, Stockholm (SE)

(21) Appl. No.: 15/050,566

(22) Filed: Feb. 23, 2016

(51) Int. Cl. G06Q 20/38; G06Q 10/02; H04L 29/08

(52) U.S. Cl. CPC G06Q 20/382; H04L 67/02; G06Q 10/02

(57) ABSTRACT

The disclosure pertains to the field of secure electronic payments. More particularly the disclosure relates to using secure electronic payment information for facilitating creation of events, where a plurality of merchants are gathered at a certain time and place. The disclosure proposes a method, performed in a server arrangement for facilitating creation of events, wherein a plurality of merchants is authorized to use the server arrangement to perform electronic financial transactions. According to some aspects the disclosure proposes a method comprises providing S2 access to a secure database populated by the server arrangement, the secure database comprising individual data of the plurality of merchants, and receiving S3, from one of the plurality of merchants, a request for creating a new event, the request comprising data attributes of the new event. The method further comprises identifying S4, in response to receiving the request, potential participants of the event among the plurality of merchants, by comparing the data attributes of the request with the individual data of the plurality of merchants comprised in the database, and triggering invitations to the event, to be sent to the identified potential participants.

### TECHNICAL FIELD

The disclosure pertains to the field of secure electronic payments. More particularly the disclosure relates to using secure electronic payment information for facilitating creation of events, where a plurality of merchants are gathered at a certain time and place.

### BACKGROUND

Historically, retail merchants sell primarily from stores and shops. Recently, retail merchants have begun to offer their goods and products on the internet. In addition, small merchants generally also trade at events like markets, festivals and sporting events. One specific type of events is sales events when merchants gather to offer goods at a certain time and place. This could e.g. be an event for a specific type of goods e.g. stamps, fruit and vegetables, music, games etc. Sales events may be an important part of the business even for retail merchants as a complement to traditional sales channels.

However, events may not be planned at the location and at time where and when individual merchant wants to sell his or her goods. The individual merchants are also typically unaware of each other and event planning is today generally manual and time consuming, why the participants may need to pay high fees for participation. Hence, there is a need for improved methods for creating events.

### SUMMARY

An object of the present disclosure is to provide method and arrangements which seeks to mitigate, alleviate, or eliminate one or more of the above-identified deficiencies in the art and disadvantages singly or in any combination and to provide a solution wherein events may be automatically created. This is achieved by using information provided by a payment facilitator, who typically holds merchant information and transaction history from previous transactions, in order to identify and contact potential participants when creating events.

The disclosure proposes a method, performed in a server arrangement for facilitating creation of events, wherein a plurality of merchants is authorized to use the server arrangement to perform electronic financial transactions. The method comprises providing access to a secure database populated by the server arrangement, the secure database comprising individual data of the plurality of merchants, and receiving, from one of the plurality of merchants, a request for creating a new event, the request comprising data attributes of the new event. The method further comprises identifying, in response to receiving the request, potential participants of the event among the plurality of merchants, by comparing the data attributes of the request with the individual data of the plurality of merchants comprised in the database, and triggering invitations to the event, to be sent to the identified potential participants.

The server arrangement is typically owned by a payment facilitator or a bank. Because the server arrangement has access to individual data of a plurality of merchants, it is possible to trigger invitations to potential participants without exposing potentially confidential data. Thereby, creation of events is facilitated. According to some aspects, the method comprises receiving responses to the invitations, from the identified potential participants and sending to the merchant sending the request, information about merchant's that have accepted the invitations to the event.

Thereby, the organizer is provided with information without exposing secure information about any merchant that has not accepted the invitation. Hence, the content in the secure database is never exposed.

According to some aspects, the identifying comprises comparing the data attributes with data associated with financial transactions performed by the plurality of merchants. According to some aspects, the identifying comprises comparing the data attributes with data entered by the merchant at registration. Both information provided by the merchants themselves as well as statistics relating to their previous activities may be used. Hence, good basis for selection is provided.

According to some aspects, the method comprises authorizing the request using an authorization of the merchant to perform electronic financial transactions. Hence, authorization can be performed without implementing additional security, as the server arrangement already has secure connection to the merchants. According to some aspects, the data attributes of the event comprises at least one of; time data, position data and event category data. For example, the identifying comprises identifying merchants positioned within an area derived from the data attributes of the event. Thus, invitations are sent to merchants that are already in the relevant area.

According to some aspects, the identifying comprises identifying merchants in the secure database, having a merchant and/or product category corresponding to the data attributes of the event. In this way the organizer may get the desired composition of merchants at the event.

According to some aspects, the request comprises a maximum number of merchants that are allowed to accept the invitation. Then the invitations may be deactivated when the maximum number of merchants has been reached. According to some aspects, the request is received through a web interface or from a software application. According to some aspects, the request is received through a form in the web interface or in the software application.

According to some aspects, the disclosure relates to a computer program comprising computer program code which, when executed, causes a server to execute any aspect of the methods described above and below.

According to some aspects, the disclosure relates to a server arrangement, configured to be used by a plurality of authorized merchants when performing electronic financial transactions. The server arrangement comprises a merchant interface for communicating with a plurality of merchants, a database interface providing access to a secure database populated by the server arrangement, the secure database comprising individual data of the plurality of merchants, and processing circuitry. The processing circuitry is further configured to cause the server arrangement to receive, using the merchant interface, from one of the plurality of merchants, a request for creating a new event, the request comprising data attributes of the new event, to identify, in response to receiving the request, potential participants of the event among the plurality of merchants, by comparing the data attributes of the request with the individual data of the plurality of merchants accessible over the database interface, and to trigger invitations to the event, to be sent to the identified potential participants.

According to some aspects, the disclosure relates to a system for facilitating creation of events, comprising the server arrangement and a secure database populated by the server arrangement, comprising individual data of the plurality of merchants.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates merchants being served by a server arrangement.

FIGS. 2a and 2b illustrates the concept of events.

FIG. 3 illustrates communication between a server and merchant, when creating an event.

FIG. 4 illustrates the method for facilitating creation of events according to some example embodiments.

FIG. 5 illustrates a system comprising a server for facilitating creation of events according to some example embodiments.

FIG. 6 illustrates a form for creating a new event.

### DETAILED DESCRIPTION

Aspects of the present disclosure will be described more fully hereinafter with reference to the accompanying drawings. The apparatus disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In today's commerce, merchants often utilize so called point-of-sale, POS, terminals, including mobile POS, mPOS, devices to process financial transactions, such as in particular credit card payments.

A point of sale terminal, POS terminal, is an electronic device used to process card payments at retail locations. A POS terminal is generally configured to read the information off a customer's credit or debit card. The card interface may be e.g. a chip card interface, a magnetic stripe card reader or an interface for reading contactless cards such as NFC. Advanced POS terminals are typically equipped with a combination of these interfaces.

The POS typically also checks whether the funds in a customer's bank account are sufficient or it decides that the transaction may be approved without checking the funds. The POS then transfers the funds from the customer's account to the seller's account or at least, accounts for the transfer with the credit card network. POS terminals may also be configured to record the transaction and to provide a digital or printed receipt.

An mPOS (mobile point of sale) is a smartphone, tablet or dedicated wireless device that performs the functions of a cash register or electronic point of sale terminal. mPoS enables small merchants to transform phones and tablets into card acceptance solutions just by connecting them to a card reader.

The mPOS technology is a perfect fit for merchants trading at events like markets, festivals and sporting events, because it's low-cost, easy to set-up and completely portable. The merchants some of whom thought their business was too small or lacking the necessary infrastructure to accept card payments, gain benefits including increased speed of service, greater security and also returning customers. At peak times during an event, mPOS terminals may enable hundreds of cashless transactions per minute. All the while, these customers could avoid queuing at ATMs, and enjoy shorter waits at the stalls.

An mPos is e.g. a smartphone, tablet or dedicated wireless device that performs the functions of a cash register or electronic point of sale terminal.

While a POS can operate as a stand-alone device that's simply linked to the bank account of the business, an mPOS is often registered at a payment facilitator, whose main task is to conduct transactions for a plurality of clients. The payment facilitators in addition to the actual payments provide additional services such as provision of receipts, accounting, follow up on sales.

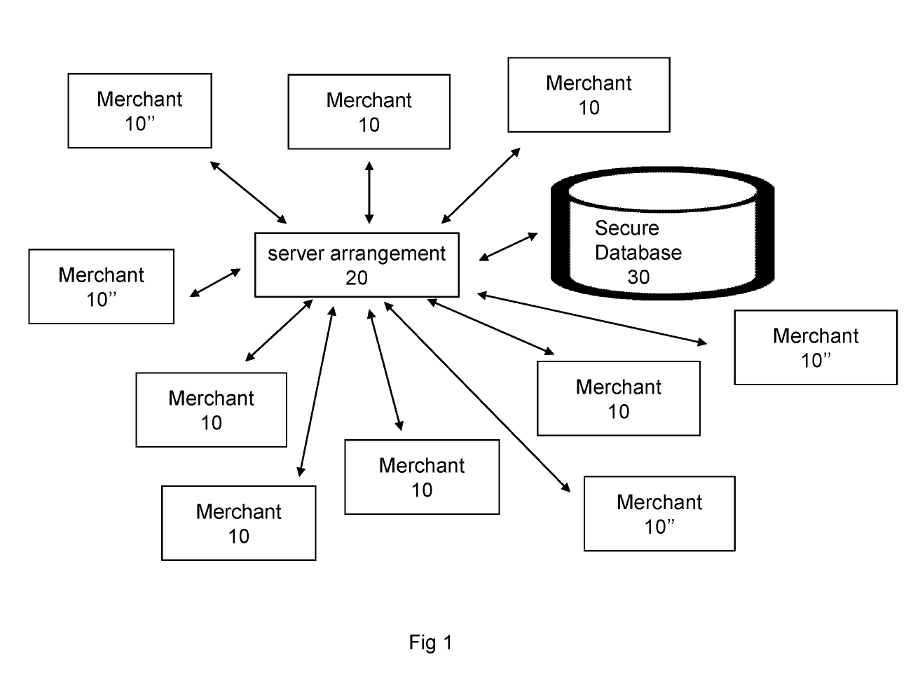

FIG. 1 illustrates merchants 10 being served by a server arrangement 20 for performing financial transactions. A financial provider e.g. provides mPOS hardware and software to multiple merchants. The hardware is typically card reader means and a payment backend, here referred to as a server arrangement 20. The software may run in the merchants own device e.g. a smartphone or tablet as well as in the backend 20. Before the merchant can start using the mPOS, the server arrangement might be required to register, at the financial provider, information of the merchant such as name, address, ownership, type of merchant, average transaction amounts, average turnover, seasonal changes in the business etc.

The server arrangement 20 typically uses a secure database 30 for storing information relating to the transactions. The database may also comprise merchant information provided e.g. at the registration or added later by the merchant. The proposed server arrangements may be managed by any payment facilitator, bank or other company handling financial transactions arrangements for multiple merchants.

The inventors have realized that information held e.g. by payment facilitators is also usable for providing an automated way of creating events of merchants being in the vicinity of each other. Such information is generally not available to the merchants, because of its confidential nature. However, by including the proposed methods for creating events in the server arrangement, sharing of individual client information is not needed, because the server arrangement itself has access to individual data of several merchants. As the event is created in the server arrangement, the information does not need to be exposed outside the server arrangement. Furthermore, the server arrangement is already provided with means for secure communication with the merchants. The service provider may ask the merchants for permission to expose information to other clients. It may also be voluntary to participate in event creation. Hence, some merchants may choose not to receive any invitations. Hence, it is possible to assist in creating the events, while only sharing non-sensitive information between the merchants.

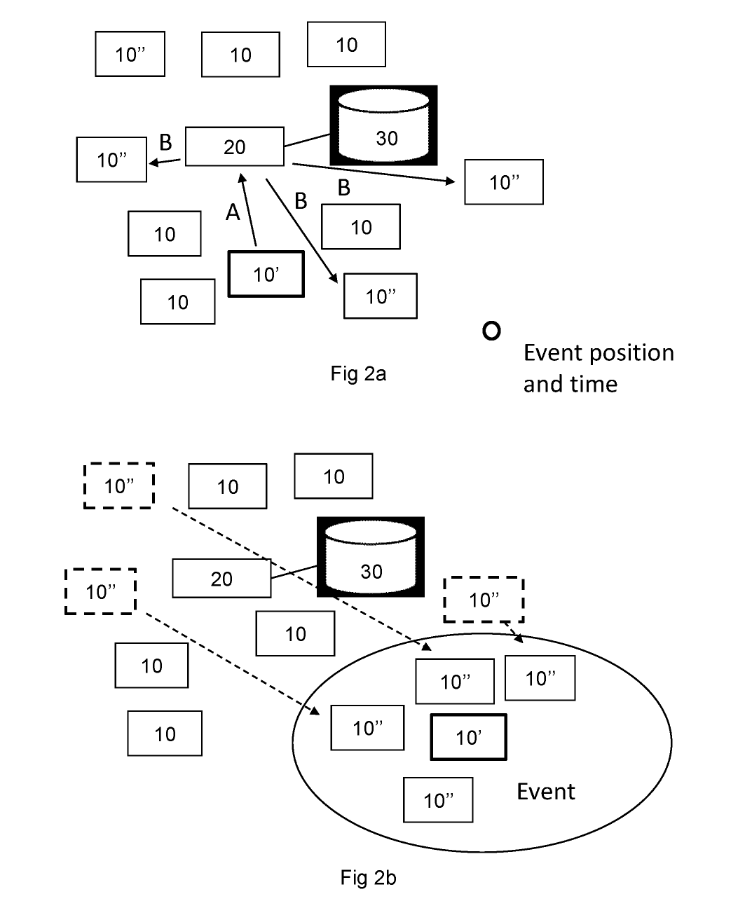

The concept is illustrated in FIG. 2a and FIG. 2b. In FIG. 2a one merchant 10′ wants to create an event. For example, this is a merchant of vegetables who wants to create a small market for local food on his farm. The merchant 10′ then wants to arrange a new event. The merchant uses a payment facilitator for receiving credit card payments via his smartphone. The financial provider has a server arrangement, such as a cloud implemented payment backend for handling payments and other related functions. The merchant then sends a request A for a new event to the server arrangement. This is e.g. done via a web interface or a software application in his smartphone. The request A specifies when and where the event should take place. The request A may also comprise other requirements of the customers.

The server arrangement comprises information related to other merchants that is usable for finding potential participants 10″ matching the requirements of the request. Hence, based on the request, potential participants 10″ may be identified, because the financial provider has access to information about the merchants and also knows which merchants are presently active in the area.

The server arrangement then sends invitations B to the identified merchants. Those merchants that are interested may then participate in the event at the specified time and place, as illustrated in FIG. 2b. Hence, an event has been created by minimal effort from any party.

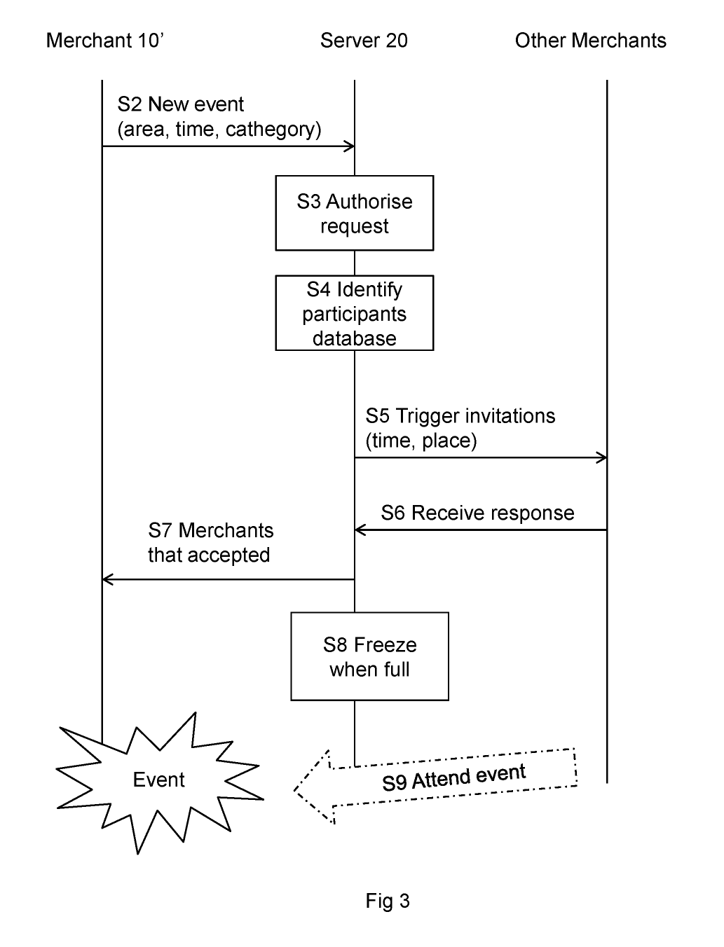

To better understand the concept; the interaction between a server and the merchants, when creating an event is described referring to FIG. 3. The method typically comprises the following steps:
1) One merchant 10′ creates a new event S2 with a venue and date (the merchant is responsible for the venue) in a user interface e.g. in an app or in a web interface, and sends request to server arrangement 20.
2) Authority of the merchant to use the service of facilitating events is checked S3 in the server arrangement 20.
3) Requirements of the new event are matched S4 with the data comprised in the secure database of merchants served by the server arrangement 20, to identify relevant merchants. Examples of requirements are
   a. restrict event to radius x km from venue, based on merchants' registered addresses and locations for transactions the last month.
   b. match for text in all merchants' product libraries or product categories e.g. “Banana” is already categorized under “fruit”.
4) Invitations are sent S5 to the relevant merchants via email, app and portal.
5) Some merchants accept S6 the invite, which may involve some kind of confirmation and deposition, to make sure that they are actually coming.
6) The merchants that accepted are introduced S7 to the organizing merchant.
7) When the event is full, the invites are inactivated S8 and no more responses are accepted. If further responses are received, the merchants are notified that the event is full.
8) Merchants that have accepted the invitation travel to the specified location to attend S9 the event and the event can start.

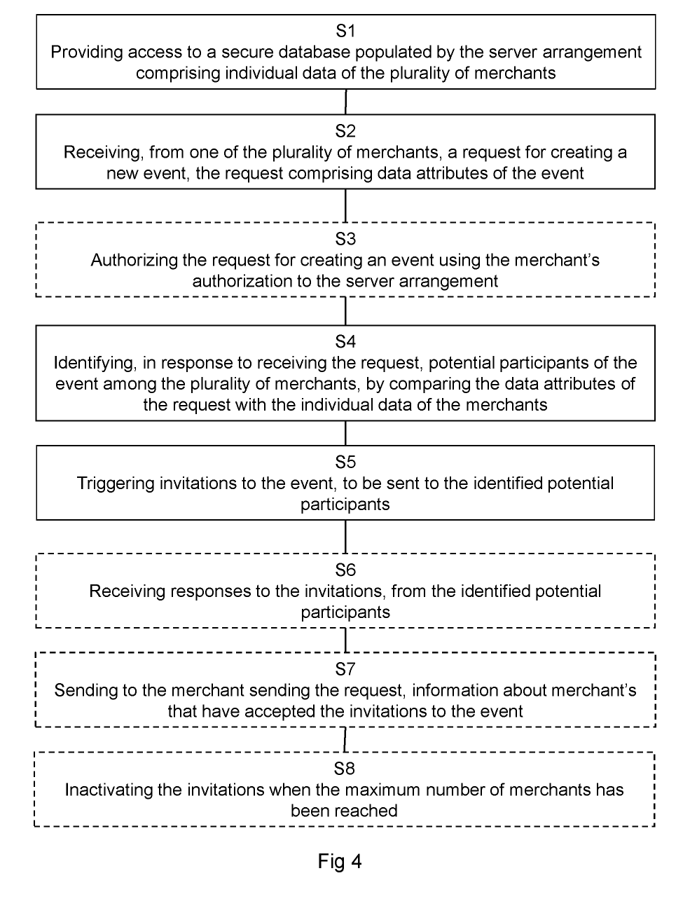

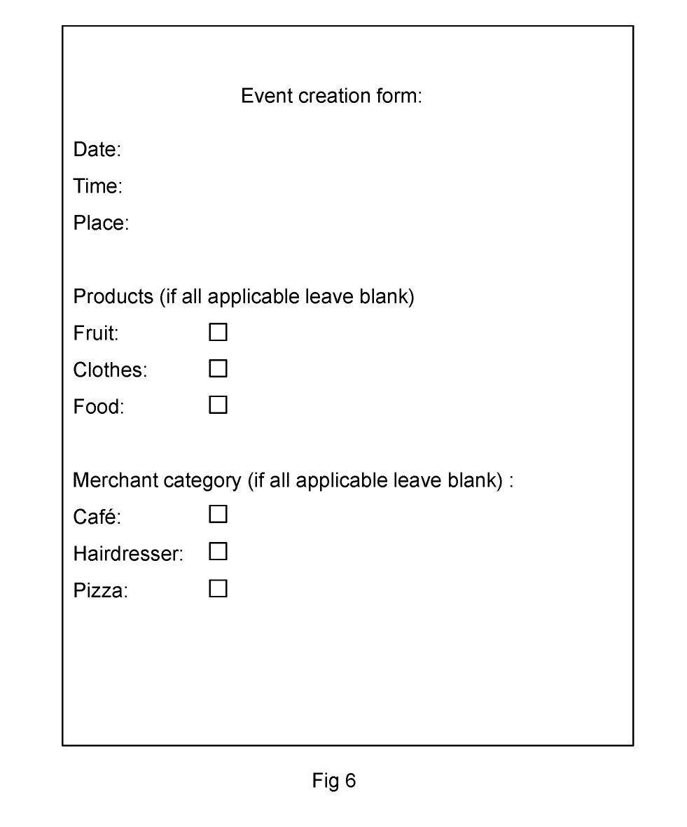

A method performed in a server arrangement for facilitating creation of events, will now be described with reference to FIG. 4. The method may be executed at any time when one merchants wishes to gather a plurality of merchants at a certain time and place and wherein a plurality of merchants are authorized to use the server arrangement to perform electronic financial transactions. For example, each merchant holds a user account at the payment facilitator, who owns the server arrangement. The server arrangement is then e.g. accessed through a web interface or a software application, where a merchant logs in using credentials such as username and password. One possible implementation is to provide a form for creating a new event in the web interface or software interface where the details of the new event can be entered. FIG. 6 shows an example of such a form. In other words, in order to initiate creation of an event means the merchant e.g. adds information about when (date and time) and where (location) they want other merchants to join them. Functionality, to create such an event should be provided by the holder of the server arrangement, but the venue is the organizer's responsibility. It is of course possible that the organizer wants a specific theme (e.g. food, clothes, summer-celebration etc.) on the event, but that is no requirement. The event creating merchant, also called organizer, then adds information about what other merchants, and how many, it wants to join the event, based on e.g. products, merchant categories.

The method also comprises providing S1 access to a secure database populated, or filled with data, by the server arrangement, the secure database comprises individual data of the plurality of merchants. In other words, the server arrangement can read data from and write data to the database. The merchant's main use of the server arrangement 20 is performing electronic financial transactions. When performing financial transactions, data associated with the electronic financial transactions are stored in one or several databases. Hence, when referring to a database, this may also refer to a group of databases. Some data in the secure database is entered by the merchants themselves e.g. at registration. Data is also stored later e.g. during the transactions. For example time, place, product category and amount of previous transactions of the respective merchants are stored. This information is usable for identifying potential participants of a coming event. The secure database is either external or it is a part of the server arrangement.

The method further comprises receiving S2, from one of the plurality of merchants 10′, a request for creating a new event, the request comprising data attributes of the new event. According to some aspects, the request is received through a web interface or from a software application. According to some aspects, the request is received through a form in the web interface or in the software application. Hence, a typical way of creating an event is that a merchant i.e. an organizer, logs in into a web interface provided by a financial facilitator and selects the service “create event”. Then, the organizer is asked to fill in a form, where the necessary details are entered. When pressing send, the request is sent to the server arrangement. When receiving the request the server arrangement identifies and notifies potential clients as described in steps S1 to S5 above. The organizer is then notified about other merchants that have accepted.

The method further comprises identifying S4, in response to receiving the request, potential participants 10″ of the event among the plurality of merchants 10, 10′, 10″, by comparing the data attributes of the request with the individual data of the plurality of merchants comprised in the database. In other words, the individual data of other merchants is read from the secure database and compared with the data attributed specified in the request. As discussed e.g. merchants with a matching category or position are identified by comparing the data of the request with individual data regarding other merchants comprised in the secure database.

According to some aspects, the data attributes of the event comprises at least one of; time data, position data and event category data. In other words, the data attributes define when and where the event takes place. The data attributed in some embodiments also define merchant categories etc. These attributes are used for identifying the potential participants. The data attributes may define anything relating to the event, such as activities taking place at the event e.g. presentation of new products. For example, the identifying comprises identifying merchants in the secure database, having a merchant and/or product category corresponding to the data attributes of the event.

According to some aspects, the identifying S4 comprises comparing the data attributes with data associated with financial transactions performed by the plurality of merchants. The secure database typically comprises individual transaction history for each one of the merchants. In other words, information is available about when, where and by whom transactions were executed. The transaction information in some cases also defined a product category. For example, information about merchants that have performed transactions relating to goods of a certain category e.g. fruit, within a predefined area within a certain time frame is identified. In other words, according to some aspects, the identifying comprises identifying merchants positioned within an area derived from the data attributes of the event.

According to some aspects, the identifying S4 comprises comparing the data attributes with data entered by the merchant at registration. The identification of potential customers may also be based on parameters entered at registration or at a later time on the merchant's own initiative, such as merchant category, nationality etc. The method also comprises triggering S5 invitations to the event, to be sent to the identified potential participants 10″. When potential participants are identified they should be informed about the possibility to attend the event. However, due to confidentiality reasons it may not be possible to inform the merchant 10′ sending the request about potential participants 10″. Then, the potential participants 10″ need to be invited, without interaction of the merchant 10′ sending the request. According to some aspects the invitations are sent from the server arrangement to the potential participants. However, the server arrangement may also trigger a third party such as an extern mail server, to send the invitations to the potential participants.

When the potential participants receive the invitations, they may select to accept the invitations. This may require that a deposition is paid, in order to avoid that they are accepting, but not showing up. According to some aspects, the method comprises receiving S6 responses to the invitations, from the identified potential participants 10″ and sending S7 information about merchant's that have accepted the invitations to the event, to the merchant sending the request 10′. In other words, the organizer may be informed about the number of participants.

According to some aspects, the method comprises authorizing S3 the request using the merchant's authorization to perform electronic financial transactions. As discussed above, the server arrangement does not provide the server services to facilitate creating events to any merchant, but typically only to its own clients. Hence, when receiving a request for a new event, some sort of authorization generally takes place. The identity of the merchant sending the request may typically be validated, e.g. by a previous login to the interface or the application used to send the request. Even the request may be authenticated using suitable security protocol.

According to some aspects, the request comprises a maximum number of merchants that are allowed to accept the invitation. Then the method according to some aspects comprises inactivating S8 the invitations when the maximum number of merchants has been reached. In other words, when one category is full, further merchants of the concerned category are prevented from accepting. Possibly they may be informed that they are now on a waiting list, in case other merchants cancel. According to some aspects, the disclosure pertains to a computer program comprising computer program code which, when executed, causes a server to execute any of the aspects of the methods described above.

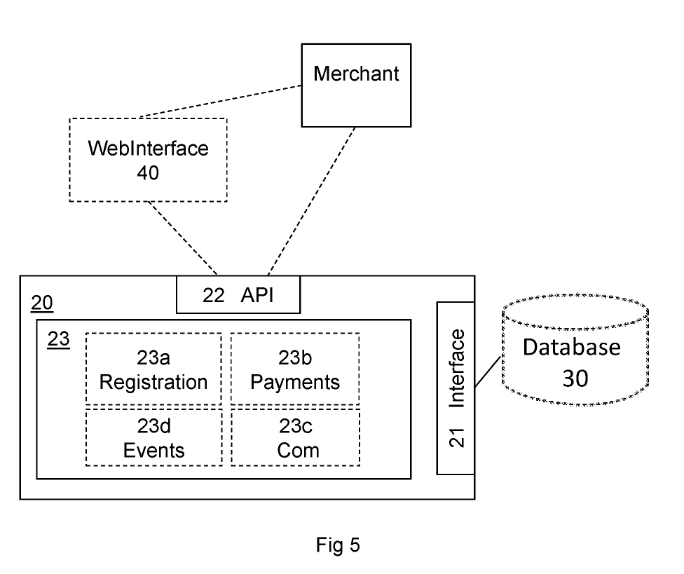

FIG. 5 illustrates an example of a system which may incorporate some of the example embodiments discussed above. As shown in FIG. 5, the system comprises a server arrangement 20, configured to be used by a plurality of authorized merchants when performing electronic financial transactions. The system also comprises a secure database.

The secure database 30 or simply “storage” 30 may comprise any form of volatile or non-volatile computer readable memory including, without limitation, persistent storage, solid state memory, remotely mounted memory, magnetic media, optical media, random access memory (RAM), read-only memory (ROM), removable media, or any other suitable local or remote memory component. Storage 30 may store any suitable instructions, data or information, including software and encoded logic.

The server arrangement 20 comprises a merchant interface 22 for communicating with a plurality of merchants, a database interface 21 and processing circuitry. The database interface 21 provides access to a secure database populated by the server arrangement, the secure database comprising individual data of the plurality of merchants.

The merchant interface 22 is an interface that enables the merchant to communicate with the server arrangement. The merchants use the interface e.g. for registration, for conducting payments and to follow up on sales activities. The merchant interface is typically also used for creating events. The merchant interface is for example an application programming interface API accessible by a Web Interface 40 or directly by the merchant by a dedicated software application.

Processing circuitry 23 controls the operation of the server arrangement. The processing circuitry 23 may be any suitable type of computation unit, e.g. CPUs, server arrangements, microprocessors, or any other form of circuitry. It should be appreciated that the processing circuitry need not be provided as a single unit but may be provided as any number of units or circuitry. The processing circuitry may also be a cloud implementation distributed over several servers.

The processing circuitry typically comprises functional blocks for registration of merchants 23a, conduction of payments 23b, for communication 23c and for creating events 23d. All these functional units may be distributed in different ways depending on implementation. The server may comprise many different other functional units not described herein.

According to the proposed methods, the processing circuitry is configured to cause the server arrangement to receive, using the merchant interface 22, from one of the plurality of merchants 10′, a request for creating a new event, the request comprising data attributes of the new event and to identify, in response to receiving the request, potential participants 10″ of the event among the plurality of merchants 10, 10′, 10″, by comparing the data attributes of the request with the individual data of the plurality of merchants accessible over the a database interface 21. The processing circuitry is further configured to trigger invitations to the event, to be sent to the identified potential participants 10″.

In some embodiments, the components described above may be used to implement one or more functional modules used in facilitating creation of events. The functional modules may comprise software, computer programs, sub-routines, libraries, source code, or any other form of executable instructions that are run by, for example, a processor. In general terms, each functional module may be implemented in hardware and/or in software. Preferably, one or more or all functional modules may be implemented by processing circuitry 23, possibly in cooperation with storage 30. Processing circuitry 23 and storage 30 may thus be arranged to allow processing circuitry 23 to fetch instructions from storage 30 and execute the fetched instructions to allow the respective functional module to perform any features or functions disclosed herein. The modules may further be configured to perform other functions or steps not explicitly described herein but which would be within the knowledge of a person skilled in the art.

Further optional features that may be supported in order to provide further benefits to a user will now be briefly described. This type of information may be included in the invitations to the events.

Income from the event may be shared by participants. For example x % of each merchant's sales is shared equally between the participating merchants.

The owner of the server arrangement can lower the transaction fee during this event, as a sponsored incentive. The owner of the server arrangement can also arrange an event like this in order to increase number of payments performed.

Participating merchant's product libraries may be combined, to create joint campaigns.

As an extra service, local merchants that do not participate in the event may be informed of the event when it has started (if the organizer allows). The principle can also be applicable for merchants that have free space at their store or similar, to find a new tenant.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A method, performed in a server arrangement for facilitating creation of events, wherein a plurality of merchants are authorized to use the server arrangement to perform electronic financial transactions, the method comprising:
providing (S1) access to a secure database populated by the server arrangement, the secure database comprising individual data of the plurality of merchants,
receiving (S2), from one of the plurality of merchants, a request for creating a new event, the request comprising data attributes of the new event,
identifying (S4), in response to receiving the request, potential participants of the event among the plurality of merchants, by comparing the data attributes of the request with the individual data of the plurality of merchants comprised in the database, and
triggering (S5) invitations to the event, to be sent to the identified potential participants.

2. The method of claim 1, comprising:
receiving (S6) responses to the invitations, from the identified potential participants, and
sending (S7) to the merchant sending the request, information about merchant that have accepted the invitations to the event.

3. The method of claim 1, wherein the identifying (S4) comprises comparing the data attributes with data associated with financial transactions performed by the plurality of merchants.

4. The method of claim 1, wherein the identifying (S4) comprises comparing the data attributes with data entered by the merchant at registration.

5. The method of claim 1, comprising:
authorizing (S3) the request using an authorization of the merchant to perform electronic financial transactions.

6. The method of claim 1, wherein the data attributes of the event comprises at least one of; time data, position data and event category data.

7. The method of claim 1, wherein the identifying comprises identifying merchants positioned within an area derived from the data attributes of the event.

8. The method of claim 1, wherein the identifying comprises identifying merchants in the secure database, having a merchant category and/or product category corresponding to the data attributes of the event.

9. The method of claim 1, wherein the request comprises a maximum number of merchants that are allowed to accept the invitation.

10. The method of claim 9 comprising:
inactivating (S8) the invitations when the maximum number of merchants has been reached.

11. The method of claim 1, wherein the request is received through a web interface or from a software application.

12. The method of claim 11, wherein the request is received through a form in the web interface or in the software application.

13. The method of claim 1, wherein the financial transactions are secure credit card payments.

14. A computer program comprising computer program code which, when executed, causes a server to execute the methods according to claim 1.

15. A server arrangement, configured to be used by a plurality of authorized merchants when performing electronic financial transactions, the server arrangement comprising:
a merchant interface for communicating with a plurality of merchants;
a database interface providing access to a secure database populated by the server arrangement, the secure database comprising individual data of the plurality of merchants, and
processing circuitry configured to cause the server arrangement:
to receive, using the merchant interface, from one of the plurality of merchants, a request for creating a new event, the request comprising data attributes of the new event,
to identify, in response to receiving the request, potential participants of the event among the plurality of merchants, by comparing the data attributes of the request with the individual data of the plurality of merchants accessible over the a database interface, and
to trigger invitations to the event, to be sent to the identified potential participants.

16. A system for facilitating creation of events, the system comprising:
a server arrangement, according to claim 15 and
a secure database populated by the server arrangement, comprising individual data of the plurality of merchants.
